(19) United States
(12) Patent Application Publication
(10) Pub. No.: US 2014/0245539 A1
(43) Pub. Date: Sep. 4, 2014

(54) INCLINATION DEVICE FOR BEDDING PROVIDE WITH AIR BAG

(71) Applicant: Kazuo Ooba, Higashi-Matsuyama-shi (JP)

(72) Inventor: Kazuo Ooba, Higashi-Matsuyama-shi (JP)

(21) Appl. No.: 14/235,981

(22) PCT Filed: Aug. 8, 2012
(86) PCT No.: PCT/JP2012/070195

§ 371 Date: May 2, 2014

(30) Foreign Application Priority Data
Aug. 29, 2011 (JP) 2011-185538

(51) Int. Cl. A61G 7/005; A47C 27/08; A61G 7/05

(52) U.S. Cl. CPC A61G 7/005; A61G 7/05; A47C 27/083
USPC 5/636; 5/655.3

(57) ABSTRACT

Provided is an inclination device for bedding that is portable and enables suppression of apnea and stertor when sleeping. The inclination device for bedding is provided with a rectangular inclination surface on which the human body rests, and a fluid bag that is disposed below the inclination surface and expands into a triangular column shape or the like by providing a fluid. A support part which is a long part at both ends of the inclination surface is disposed at a location where the support part is in contact with the bedding. The inclination surface can be inclined left and right by providing liquid to the liquid bag, with the support part of the inclination surface serving as the fulcrum. In particular, the following structure is preferable: by installing at least two fluid bags in a stacked state, expansion is performed in a fan shape with the fixed part of the fluid bag serving as the fulcrum.

### TECHNICAL FIELD OF THE INVENTION

The present invention relates to the inclination device for bedding and, in particular, relates to the inclination device for bedding that is portable and enables suppression of apnea and stertor when sleeping.

### BACKGROUND ART

Conventionally, the various type is known as a pillow for proneness used when sleeping by proneness. For example, when sleeping by proneness, eyes, a nose and a mouth of human are not pressed to the patent documents 1-4, and the pillow which can breathe comfortably is indicated. Furthermore, the bedding indicated by the patent documents 5 is known from a viewpoint of preventing changing sides at the time of going to bed in the state of proneness.

Generally, the upper airway of the person when sleeping is narrow as compared with the time of having occurred. This causes hypersomnia with periodic apnea.

And when sleeping, strain of the muscles of a jaw solves and a jaw falls to the direction in the inner part of a throat. For this reason, the breathing resistance of the person under sleeping is large compared with the time of awake. Furthermore, according to physical exhaustion, stress, cold, etc., those who have caused nasal congestion open a mouth and breathe. When an air will enter into a mouth, the pressure in a mouth will rise and the root of a tongue will sink, an upper airway becomes narrow.

Conventionally, the operation using a commercial medicine, the goods for various kinds of snore prevention as how to prevent sleep apnea syndrome and a snore was known. For example, a nasal spray is effective in preventing sleep apnea syndrome and a snore by improving congestion of nasal mucosa. However, if the nasal spray is taken for a long time, the amount used will increase gradually and side effects will happen.

And, the mask made from a plastic was known as goods for sleep apnea syndrome and snore prevention.

However, there was a problem of separating during sleeping in the goods for the conventional snore prevention.

In order to solve such a problem, the working bed was used and the method of preventing sleep apnea syndrome and a snore was known (the patent document 6.).

However, by this method, equipment with a large cylinder is required, and it was not able to carry easily.

In order to solve such a problem, the inventor in this application invented the air bag for bedding which can be carried (the patent document 9).
Patent Publication 1: Japanese Patent Laid-open Publication 1998-117905
Patent Publication 1: Japanese Patent Laid-open Publication 2006-553835
Patent Publication 1: Japanese Patent Laid-open Publication 2006-334366
Patent Publication 1: Japanese Patent Laid-open Publication 2007-50222
Patent Publication 1: Japanese Patent Laid-open Publication 2008-12217
Patent Publication 1: Japanese Patent Journal 3715900
Patent Publication 1: Japanese Patent Laid-open Publication 1987-222711
Patent Publication 1: Japanese Patent Journal 1945996
Patent Publication 1: Japanese Patent Journal 4790082

### DISCLOSURE OF THE INVENTION

### Technical Problems to be Solved by Present Invention

The object of the present invention is to provide an inclination device for bedding that is portable and enables suppression of apnea and stertor when sleeping.

Another object of the present invention is to provide an auxiliary implement for bedding which prevents pressure of the face containing the eyes, a nose and a mouth of human in a proneness state, a nose, and a mouth of human when sleeping.

Another object of the present invention is to provide the inclination speed of a slope is accelerated.

And another object of the present invention is to provide the slide of the human body accompanying the inclination of bedding is prevented, and the fall from bedding is prevented when sleeping.

### Means to Solve Technical Problems

In order to solve the above technical problems, the present invention is defined by the following elements.
(1) The inclination device for bedding is provided with a rectangular inclination surface on which the human body rests, and a air bag that is disposed below the inclination surface and expands into a triangular column shape, rectangular shape, globular shape, sector shape or cylinder shape by providing a air, and a support part which is a long part at both ends of the inclination surface is disposed at a location where the support part is in contact with the bedding, and the inclination surface can be inclined left and right by providing air to the air bag, with the support part of the inclination surface serving as the fulcrum,
(2) The inclination device for bedding according to claim 1, wherein said air bag which air bag for a left inclination which expands so that air bag nay make a slope incline on the left and air bag for a left inclination which expands so that air bag nay make a slope incline on the left are arranged by turns in the direction of a library temple of bedding.
(3) The inclination device for bedding according to claim 1 or claim 2, wherein tow or more air bags is arrange in pile that is disposed below said inclination surface, and air bag expands in the shape of a fan by using as a fulcrum the portion to which air bags was fixed to in the support part, and air bag was fixed by supplying air to the said air bags.
(4) The inclination device for bedding according to claim 1 to 3, wherein a cold air current or a stream of warm air is supplied to a slope by air bag being dual structure, forming the exhaust nozzle of air in the undersurface of inside air bag, forming the exhaust nozzle of air in the upper surface of outside air bag, and supplying cold or warmth to inside air bag.
(5) The inclination device for bedding according to claim 1 to 4, wherein the air bag expands in a form which raises the parietal region side of a human body.
(6) The inclination device for bedding according to claim 1 to 5, that is disposed the auxiliary implement for bedding is arranged under the human body lain prone.
(7) The inclination device for bedding according to claim 6, wherein said auxiliary implement has a pillow holding the head in a human body, and the concave portion is formed in the part which is equivalent to the eye, a nose and a mouth in human body at the said pillow.
(8) The inclination device for bedding according to claim 7, wherein said auxiliary implement for bedding has an auxiliary implement for legs, and guide component which supports a leg is formed in the part where said auxiliary implement for legs is equivalent to the root of the leg in a human body.
(9) The inclination device for bedding according to claim 7 or claim 8, wherein said auxiliary implement for bedding which prevents fall of a human body is formed in said auxiliary implement for bedding.
(10) The inclination device for bedding according to claim 7 to 9, wherein an air bag is disposed below auxiliary implement.
(11) The inclination device for bedding according to claim 10, wherein a cold air current or a stream of warm air is supplied to a slope by air bag being dual structure, forming the exhaust nozzle of air in the undersurface of inside air bag, forming the exhaust nozzle of air in the upper surface of outside air bag, and supplying cold or warmth to inside air bag.
(12) The inclination device for bedding according to claim 1 to 11, wherein the partition of a rectangular shape, square shape or triangle was formed in said air bag.
(13) The inclination device for bedding according to claim 1 to 12, when the oxygen concentration of saturated solution in blood is measured, and said oxygen concentration of saturated solution exceeds a predetermined threshold value from the laid human body, a driving signal is transmitted and a slope is made to incline right and left.
(14) The inclination device for bedding according to claim 1 to 13 when the air pressure in air bag is measured with a pressure sensor and said pressure exceeds a predetermined threshold value, air is discharged from air bag.

### Effect of the Invention

According to the present invention, the inclination device for bedding which exhibits is portable and enables suppression of apnea and stertor when sleeping.

In addition, the present invention is to provide an auxiliary implement for bedding which prevents pressure of the face containing the eyes, a nose and a mouth of human in a proneness state, a nose, and a mouth of human when sleeping.

In addition, the present invention is to provide the inclination speed of a slope is accelerated.

In addition the present invention is to provide the slide of the human body accompanying the inclination of bedding is prevented, and the fall from bedding is prevented when sleeping.

### BRIEF EXPLANATION OF DRAWINGS

FIG. 1 is a plan view of the first embodiment according to the present invention.

FIG. 2 is a perspective diagram view of the second embodiment according to an auxiliary implement for bedding.

FIG. 3 is a side view of the second embodiment according to the present invention.

FIG. 4 is a cross section view of the second embodiment according to the present invention.

FIG. 5 is a plan view of the third embodiment according to the present invention.

FIG. 6 is the drawing for explaining directions for use of the third embodiment.

FIG. 7 is a plan view of the fourth embodiment according to the present invention.

FIG. 8 is a perspective diagram view for explaining an action of the fourth embodiment according to the present invention.

FIG. 9 is a front view of the fourth embodiment according to the present invention.

FIG. 10 is a perspective diagram view for explaining an action of the fifth embodiment according to the present invention.

FIG. 11 is a front view of sixth embodiment according to the present invention.

FIG. 12 is a cross section view of the sixth embodiment according to the present invention.

FIG. 13 is a perspective diagram view of the seventh embodiment according to the present invention.

FIG. 14 is a perspective diagram view for explaining the air feed pipe used for the seventh embodiment according to the present invention.

FIG. 15 is a flow chart which shows the control procedure of the inclination device for bedding according to the present invention.

FIG. 16 is a flow chart which shows the control procedure for controlling the oversupply of air.

FIG. 17 is a flow chart which shows the control procedure of the inclination device for bedding according to the eighth embodiment.

FIG. 18 is a perspective diagram view of the ninth embodiment according to the present invention.

FIG. 19 is a perspective diagram view of the tenth embodiment according to the present invention.

FIG. 20 is a perspective diagram view of the eleventh embodiment according to the present invention.

FIG. 21 is a perspective diagram view of the twelfth embodiment according to the present invention.

FIG. 22 is a side view of the thirteenth embodiment according to the present invention.

FIG. 23 is a perspective diagram view showing an example of the inclination device for bedding according to the thirteenth embodiment.

FIG. 24 is a perspective diagram view of 14th embodiment according to the present invention.

### DETAILED DESCRIPTION OF THE INVENTION

The auxiliary implement used the inclination device for bedding has a pillow holding the head in the human body under sleeping. Especially, It is suitable as an auxiliary implement for bedding in the human body lain prone. The auxiliary implement holding the head in a human body, and the concave portion is formed in the part which is equivalent to the eye, a nose and a mouth in human body at the said pillow.

In addition, an air bag is disposed below auxiliary implement.

The material used for an air bag has Teflon66, nylon, Polyester, plastic material, a laminate material, urethane material, etc. Even if such materials repeat expansion and elasticity, they are excellent in flexibility and durability, lightweight, and very useful for carrying.

In addition, the back of an air bag may be coating with crude rubber. Airtightness improves by coating crude rubber at the back.

The auxiliary implement for bedding of the present invention can be carried. For example, it is also possible to use it, carrying into the hotel of a destination.

The auxiliary implement for bedding has an auxiliary implement for legs, and guide component which supports a leg is formed in the part where said auxiliary implement for legs is equivalent to the root of the leg in a human body. You may cover the above-mentioned bed for legs with the cover of cloth etc. Partial expansion of a fluid bag can be prevented by covering with a cover.

And the auxiliary implement for bedding which prevents fall of a human body is formed in said auxiliary implement for bedding. The safety stopper forms a slope by supplying fluid. Or a safety stopper makes by a urethane mat at the both ends of bedding beforehand.

The inclination device for bedding of this invention, wherein a cold air current or a stream of warm air is supplied to a slope by air bag being dual structure, forming the exhaust nozzle of air in the undersurface of inside air bag, forming the exhaust nozzle of air in the upper surface of outside air bag, and supplying cold or warmth to inside air bag.

The inclination device for bedding of this invention, wherein the partition of a rectangular shape, square shape or triangle was formed in said air bag.

The inclination device for bedding of this invention, when the oxygen concentration of saturated solution in blood is measured, and said oxygen concentration of saturated solution exceeds a predetermined threshold value from the laid human body, a driving signal is transmitted and a slope is made to incline right and left.

The inclination device for bedding according to claim 1 to 13 when the air pressure in air bag is measured with a pressure sensor and said pressure exceeds a predetermined threshold value, air is discharged from air bag.

Now, the embodiments of the present invention will be described below with reference to the drawings.

### First Embodiment

FIG. 1 is a plan view of the first embodiment according to the present invention. (a) is a plan view. (b) is (b)-(b) sectional view in (a).

The auxiliary implement for bedding concerning this embodiment 1 is the pillow 1 holding the head in the human body under sleeping. The concave portion 2 is formed in the part where the pillow 1 hits the eye, a nose, and a mouth in a human body. The fluid bag 3 is arranged under the pillow 1 which expands by supplying fluid.

As for the fluid used here, gas, such as water, oil, and air, is mentioned. It is most desirable to use air.

### Second Embodiment

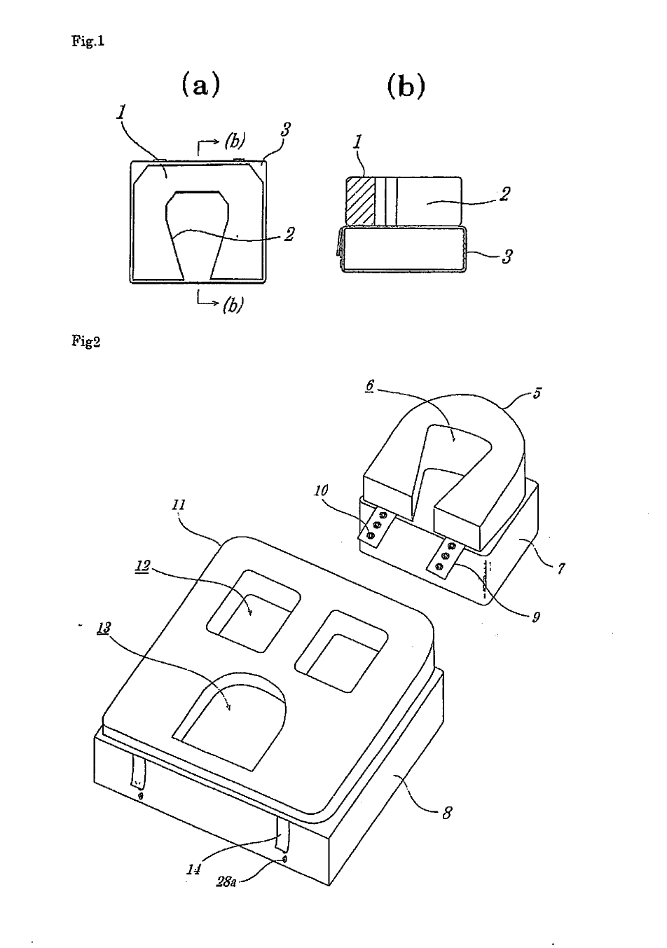

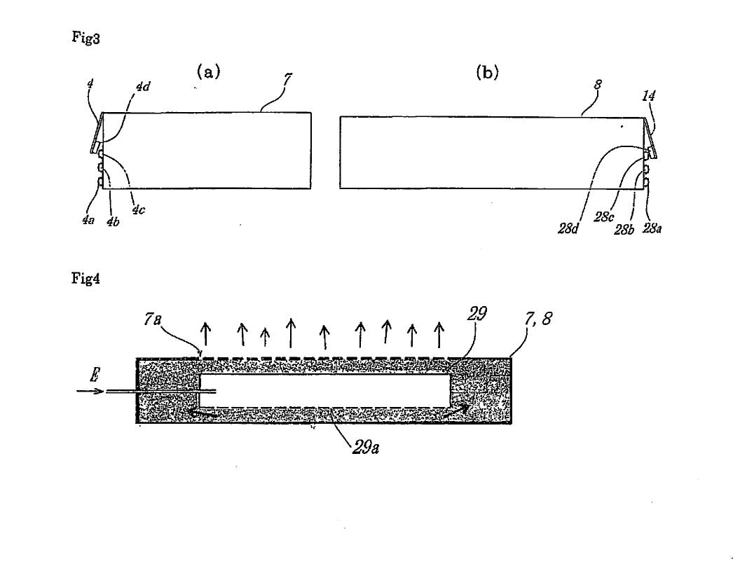

FIG. 2 is a perspective diagram view of the second embodiment according to an auxiliary implement for bedding.

The auxiliary implement for bedding concerning this embodiment 2 is the pillow 5 holding the head in the human body under sleeping. The concave portion 6 is formed in the part where the pillow 5 hits the eye, a nose, and a mouth in a human body. The fluid bag 7 is arranged under the pillow 5 which expands by supplying fluid. The length tuning component 9 is formed on the pillow 5. The hook 10 is formed in the surface of the length tuning component 9.

The auxiliary implement for bedding concerning the present invention has the chest holder 11 that holding the upper half of a human body. The hole 12 is established in the part which hits the bed 11 at people's lung. And, the hole 13 is established in the part which hits the bed 11 at the stomach of a human body.

FIG. 3 (a) is a side view of the fluid bag 7 according to the present invention. And FIG. 3 (b) is a side view of the fluid bag 8 according to the present invention.

As shown in FIG. 3 (a), The height adjustment component 4 is attached to the side of the fluid bag 7. The hook 4d is attached at the tip of the height adjustment component 4. The hooks 4a, 4b, and 4c are attached to the side of a fluid bag 7.

As shown in FIG. 3 (b), The height adjustment component 14 is attached to the side of the fluid bag 8. The hook 28d is attached at the tip of the height adjustment component 14. The hooks 28a, 28b, and 28c are attached to the side of a fluid bag 8.

The fluid bags 7 and 8 shown in FIG. 3 are lightweight, and it can carry them out to a place where one has gone easily.

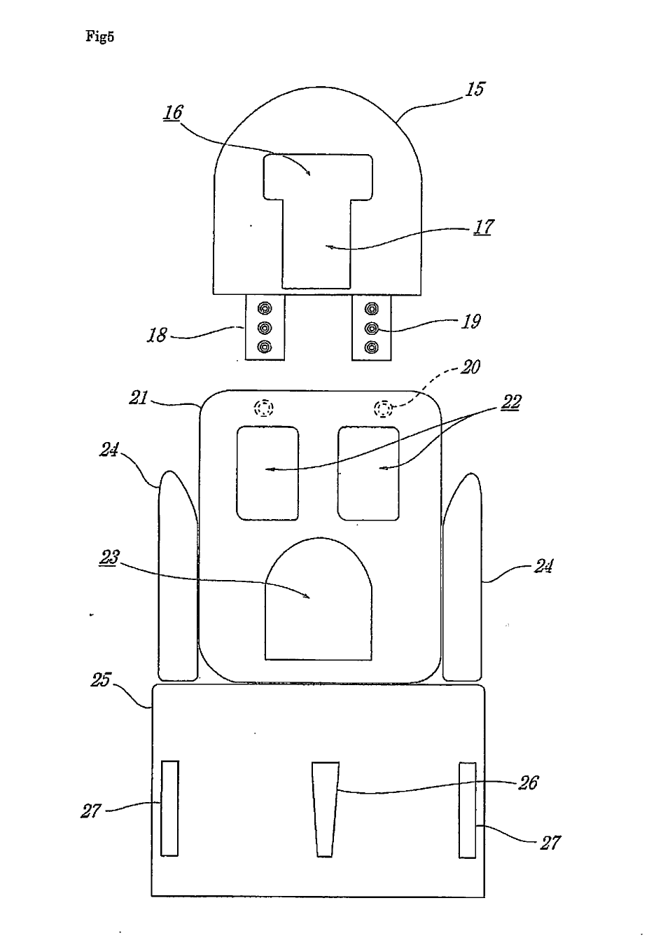

The fluid bags 7 and 8 shown in FIG. 4 are dual structure, and air hole 29a are formed in the undersurface of the inside fluid bag 29. The air around which it turned from the undersurface of the inside fluid bag 29 is exhausted from the air hole 7a of the upper surface of the outside fluid bags 7 and 8.

### Third Embodiment

FIG. 5 is a plan view of the third embodiment according to the present invention.

The auxiliary implement for bedding concerning this embodiment 3 is the pillow 15 holding the head in the human body under sleeping. The concave portion 16 is formed in the part where the pillow 15 hits the eye, a nose, and a mouth in a human body. The concave portion 17 is formed in the part where the pillow 15 hits a nose and a mouth in a human body.

The length tuning component 18 is attached to the undersurface of the pillow 15. The hook 19 is attached at the surface of the Length tuning component 18.

The auxiliary implement for bedding concerning the present invention is equipped with the bed 21 for chests holding the upper half in a human body. The concave portion 23 is formed in the part which hits the bed 21 at the lung in a human body.

The hook 20 is attached at the undersurface of the bed 21.

The safety stopper 24 is formed in the auxiliary implement for bedding concerning the third embodiment. The safety stopper 24 is formed with the air bag. The safety stopper 24 can prevent the slide of a human body, when a bed inclines.

The auxiliary implement for bedding concerning the third embodiment has the bed 25 for legs holding the leg of a human body. The shape of a Support form 26 and the Support form 27 are formed in the bed 25 for legs.

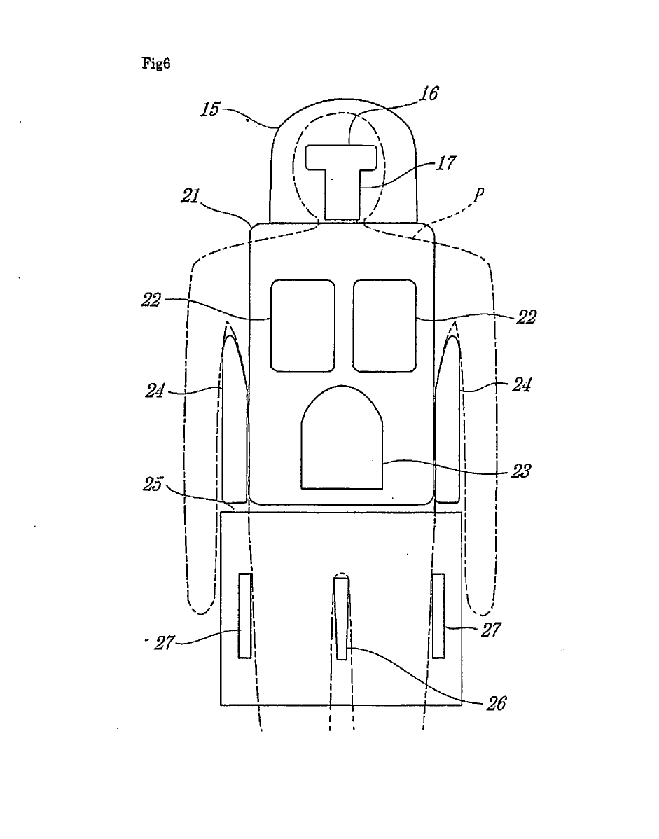

FIG. 6 is the drawing for explaining directions for use of the third embodiment.

As shown in FIG. 6, The pillow 15 in the third embodiment holds the head of the human body P under sleeping.

The concave portion 16 is formed in the part where the pillow 15 hits the eye in a human body. The concave portion 17 is formed in the part where the pillow 15 hits a nose and a mouth in a human body.

The auxiliary implement for bedding concerning the present invention is equipped with the bed 21 for chests holding the upper half in a human body. The concave portion 22 is formed in the part which hits the bed 21 at the lung in a human body. And the concave portion 23 is formed in the part which hits the bed 21 at the stomach in a human body.

The safety stopper 24 is formed in the auxiliary implement for bedding concerning the third embodiment.

The auxiliary implement for bedding concerning the third embodiment has the bed 25 for legs holding the leg of a human body. The shape of a Support form 26 and the Support form 27 are formed in the bed 25 for legs.

### Fourth Embodiment

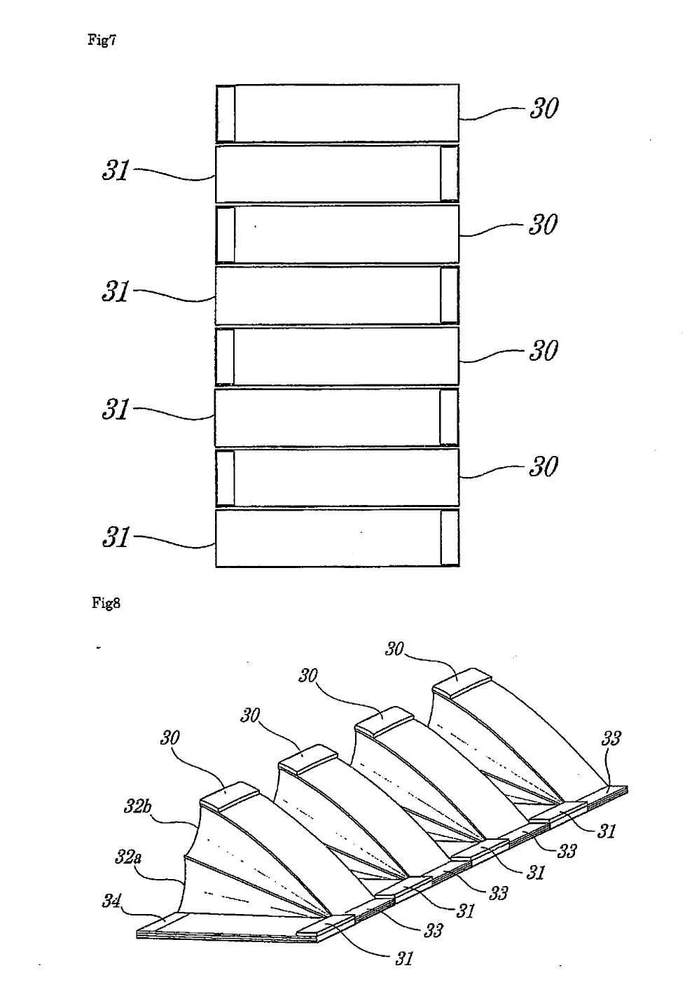

FIG. 7 is a plan view of the fourth embodiment according to the present invention.

The inclination equipment for bedding concerning the fourth embodiment has an air bag which can make a human body incline right and left. As shown in FIG. 7, the air bag 30 for inclination which makes a slope incline on the right, and the fluid bag 31 for a left inclination which makes a slope incline on the left are arranged by turns at the inclination equipment for bedding.

FIG. 8 is a perspective diagram view for explaining an action of the fourth embodiment according to the present invention.

As shown in FIG. 8, the air bag 30 for inclination to the right slant which makes the right incline expands in the shape of a triangle by supplying air. And in the direction of a library temple on bedding, the support part 33 of the air bag 30 for inclination to the right slant is arranged.

The air bag 32 on inclination device for bedding of the forth embodiment is divided in the direction of a library temple of bedding. when air is supplied to the said air bag, the two air bags 32a 32b which expand in the shape of a triangle are fixed and piled up in a support part. The slope on an air bag can be made to incline on right hand side by supplying air to an air bag.

The air bag 31 for a left inclination can make a slope incline toward left hand side. The air bag 31 for a left inclination which expand in the shape of a triangle are fixed and piled up in a support part.

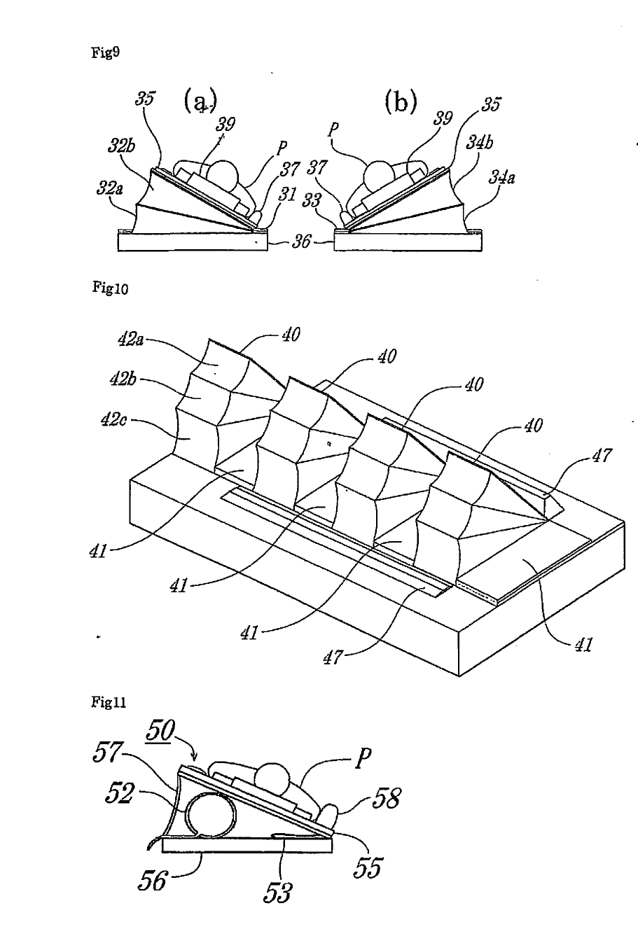

FIG. 9 is a front view of the fourth embodiment according to the present invention. The mark 35 is a slope, the mark 36 is a bed, and the mark 39 is a pillow, the mark 36 is a bed.

As shown in FIG. 9, the slope 35 can be made to incline right and left by arranging the air bag for inclination to the right slant, and the air bag for inclination to the left slant, and supplying air to the air bags 32a, 32b, 34a, and 34b by turns. FIG. 9 (a) is a figure showing the state where the slope 35 inclined on the right by supplying air to the air bags 32a and 32b. FIG. 9 (b) is a figure showing the state where the slope 35 inclined on the left by supplying air to the air bags 34a and 34b.

When the slope 35 inclines, the slide of the human body P can be prevented by expanding the safety stopper 37.

### Fifth Embodiment

FIG. 10 is a perspective diagram view for explaining an action of the fifth embodiment according to the present invention.

The inclination device for bedding concerning fifth embodiment is device equipped with the air bag which can make a human body incline right and left. As for a slope, it is desirable to use the hard one sheet component formed with urethane etc. The air bag 40 for inclination to the right slant which makes a slope incline on the right, and the air bag 41 for a left inclination which makes a slope incline on the left are arranged by turns in the direction of a library temple of bedding.

The air bag 40 for inclination to the right slant is equipped with the air bag 42 which expands in the shape of a triangle by supplying air.

The said air bag 42 is divided in the direction of a library temple of bedding at plurality. When air is supplied to an air bag, the support part of the air bags 42a, 42b, and 42c which expand in the shape of a triangle is fixed and piled up. On the other hand, the air bag 41 for a left inclination can make a slope incline toward left hand side by making a slope incline toward left hand side, and supplying air to the air bag 41 for a left inclination.

By adjusting the quantity of the air supplied to an air bag, the angle of gradient of a slope can be adjusted in angle from 0° to 80°. When you are sleeping on your stomach especially, in angle from 0° to 30° is suitable for an angle of gradient.

When the slope inclines, the slide of the human body can be prevented by expanding the safety stopper 47.

### Sixth Embodiment

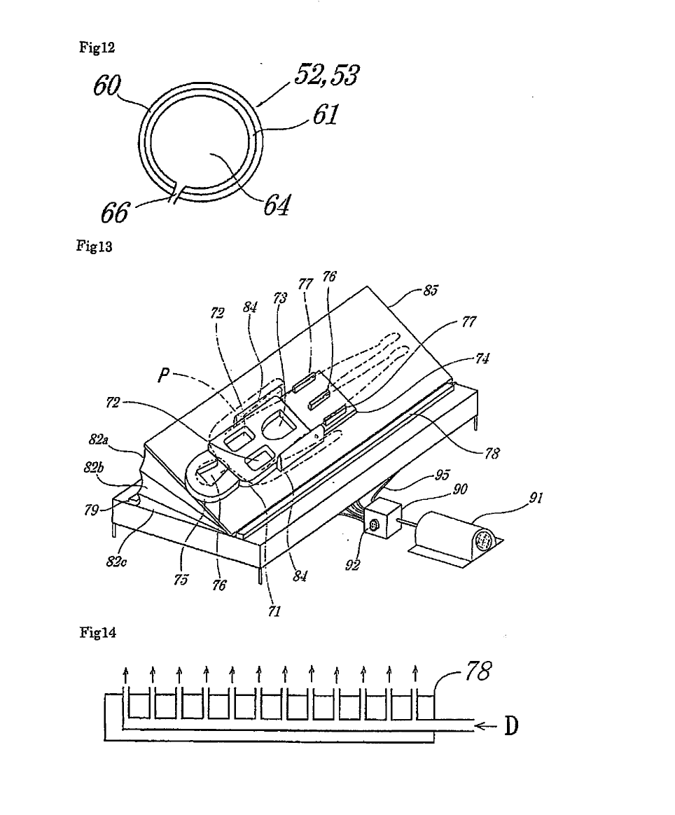

FIG. 11 is a front view of sixth embodiment according to the present invention.

As shown FIG. 11, The inclination device 50 for bedding concerning sixth embodiment is equipped with the air bags 52 and 53 which have the slope 55 on the bed 56. The slope 55 on the air bags 52 and 53 is formed with urethane resin.

The air bags 52 and 53 in FIG. 11 expand in pillar form. The slope 55 can be leaned by supplying air to the air bag 52.

It shifts in order to prevent the slide of a human body to the inclination device for bedding, and the prevention network 57 is formed.

When the slope 55 inclines, the slide of a human body can be prevented by expanding the safety stopper 58.

FIG. 12 is a cross section view of the air bags 52,53 for bedding 50 concerning sixth embodiment according to the present invention.

The air bags 52 and 53 are the two layer structure of the outer layer 60 and the inner layer 61.

### Seventh Embodiment

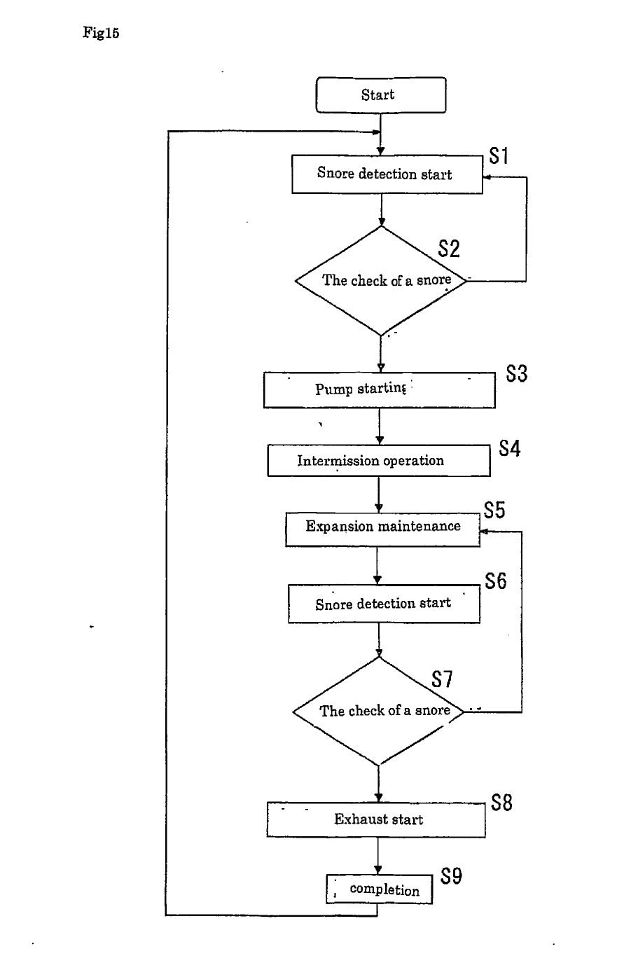

FIG. 13 is a perspective diagram view of the seventh embodiment according to the present invention.

As shown in FIG. 13, The pillow 75 holds the head of the human body P under sleeping. The pillow 75 has a penetration hole into the portion which hits the eye, a nose and a mouth in a human body.

The bed 71 for chests holds the upper half of the human body P. The bed 71 for chests has a penetration hole 72 into the portion which hits the lung in a human body. And The bed 71 for chests has a penetration hole 73 into the portion which hits the stomach in a human body.

The bed 71 for chests is equipped with the two safety stoppers 84.

The bed 74 for legs holds the leg of the human body P. The bed 74 for legs has the support medium 77 in the center of the bed and the support medium 76 at the sides of the bed.

The inclination device for bedding concerning seventh embodiment has the triangle like three air bags 82a, 82b, and 82c. As for three air bags 82a, 82b, 82c, the end adheres. An air bag expands by supplying air to the air bags 82a, 82b, and 82. The slope 85 can be leaned when an air bag expands.

The inclination device for bedding shown in the seventh embodiment is equipped with the air supply pump 91, the changeover valve, and the valve system 90.

The air taken in from the air supply pump 91 is supplied to the air bags 82a, 82b, and 82c and the safety stopper 84 from the feed pipes 95 and 78 through the valve system 90.

When the valve system 90 of seventh embodiment sends air from the supply pump 91, it is equipped with the change function for stopping the air which flows backwards through the air feed pipes 95 and 78, or exhausting from the exhaust valve 92.

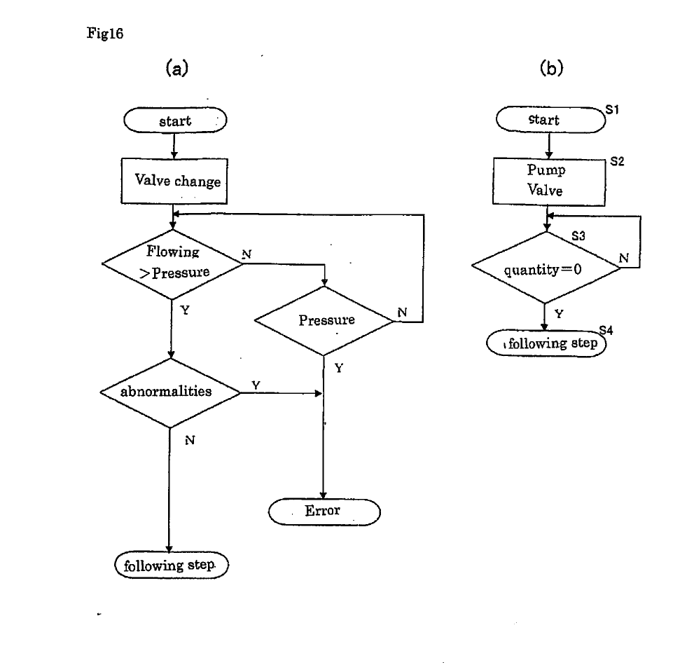

FIG. 14 is a perspective diagram view for explaining the air feed pipe used for the seventh embodiment according to the present invention.

As shown in FIG. 14, The air feed pipe 78 has a feed opening underfoot for prevention of noise.

We explain the control of the model for carrying out the invention.

FIG. 15 shows the flow chart of a control procedure of the inclination device for bedding.

In the first place, the sensor which is not illustrated, such as a throat microphone, detects apnea and snore (Step S1).

CPU of the control device, which is not illustrated, judges the existence of the apnea and snore (Step S2).

It is desirable to use especially the system which carries dsPIC (made by Microchip Company) for detection of snore.

Algorithm based on the engineering acoustics feature of snoring is used for dsPIC.

We adopt cepstrum analysis.

We adopt the cepstrum analysis currently used for pitch extraction in the field of speech information processing in order to decompose the fine structure which arises by being repeated a fixed cycle and the original spectrum of snoring.

Simple-waveform Snore can be judged from the peak frequency of a power spectrum (However, since this frequency domain may compete with the first vowel formant, it is distinguished by connect time etc.).

If the sensor has detected neither the apnea nor snoring and the CPU has judged neither the apnea nor a snore, then the above-mentioned flow is repeated.

If the sensor has detected apnea or snore and the detection signal is inputted into the CPU, then the CPU judged that a state of apnea or snore occurred, the air supply pump 91 supplies air to the air bag 82a through the air feed pipe 95, and the air bag 82a is expanded.

If it sets up beforehand, in this case, not only the air bag 82a but the air bag 82b and the air bag 82c can be expanded.

Thus, the angle of gradient to the right can be quickly formed by connecting two or more air bags beforehand.

By setting up beforehand, air can be supplied also to the safety stopper 84 from fall other than air bags.

After finishing expanding air bags etc., operation of the air pump is changed to intermission operation, and the expansion of air bags etc. is maintained (Step S4).

The closed state by valve system 90 maintains in air bags etc. the air supplied to the air bag as it is, and the expanding state is maintained for a predetermined period by this (Step S5).

When maintaining the expanding state, the sensor resumes a detection of apnea or snoring (Step S6) and it is judged whether apnea or snoring generated the CPU based on the detection result (Step S7).

The process of Step S6 and Step S7 can be skipped, and it can also be made to shift to the process of Step S5 to Step S8.

That is, in the state where the expansion of air bags is maintained (Step S5), it can shift to the process which makes exhaust of air start through the exhaust valve by the timer, without carrying out re-detection of snoring.

When the sensor dose not detect apnea and the CPU judges the stop of apnea, the air can be exhausted through the exhaust valve 92 of the valve system 90, air bags etc. can be shrunk, and the expanding state can be canceled.

Under the present circumstances, the supplied air is exhausted within 30 minutes and the inclined bed is returned horizontally.

As a method of exhaust of air, the method of exhausting in about 60 to 90 seconds can also be chosen.

A magnet valve can be chosen as the exhaust valve 92.

Air can also be exhausted from the insertion pump side.

Subsequently, air is supplied to the air bags for forming the angle of gradient to the left through air feed pipe 95.

As mentioned above, when maintaining the expanding state of a air bag etc. in this enforcement form, while judging the existence of a recurrence of the apnea etc. based on the detection result of a sensor, A bed can be made to incline toward right-and-left both directions by controlling supply and an exhaust gas of the air to a air bag etc. by control of an air supply pump and a valve system according to the existence of a recurrence of breathing from a human body.

Sleep apnea syndrome and snore can deter and it can secure comfortable sleep.

As other control methods of this embodiment, a manual system may be chosen by manual operation.

An example of the manual system is explained below.

In the first place, a bedtime hour after a user goes into the bed until he will go to sleep is set up.

For example, when reading a book for 50 minutes before sleeping, “50 minutes” is set up as “bedtime hour.”

When a user is going to go to sleep immediately, “bedtime hour” should just be set up, for example among “0 to 5 minutes.”

In the second, standby time after a user is going to go to sleep until he actually sleeps is set up.

For example, if an early person goes into the sleep state, “8 minutes” will be set up as “standby time”, and if a late person goes into the sleep state, “30 minutes” will be set up as “standby time.”

On the average, it sets up among “15 to 20 minutes.”

In the third, the air supply (pressurization) time which supplies air to air bags is set.

In order to make the bed incline, it is required to open an electromagnetic valve and to supply air to a air bag.

At this time, the supply time of air is influenced by the function of the air pump.

That is, it is decided by the amount of air jet of the air pump, the machine time of it, and the size of air bags.

For example, when using the air pump which needs 5 minutes until it makes the angle of gradient of the bed into 80 degrees, “5 minutes” is set up as “supply time of air.”

The inclination of a bed can be sped up by using an air pump with a higher function.

However, when the bed is leaned to 80 degrees within 1 minute, there is a possibility of becoming the hindrance of sleeping. Therefore, it usually sets up in 1 minute or more and about 5 minutes or less.

In the forth, the inclination stop time for maintaining the formed angle of gradient of the bed is set up.

For example, “40 minutes” can be set up as “inclination stop time.”

Usually, it is suitable as a measure against sleep apnea syndrome under sleep to set up “30 to 60 minutes.”

In the fifth, the air exhaust (decompression) time which exhausts air from air bags is set up.

Usually, probably, it will be desirable to set up the air exhaust time equally to the air supply time which is the third process of the above.

Rising time can also be set up in this one of examples for carrying out the invention.

For example, if rising time is set as “6:00 a.m.”, the inclination of the bed is cancelable by it.

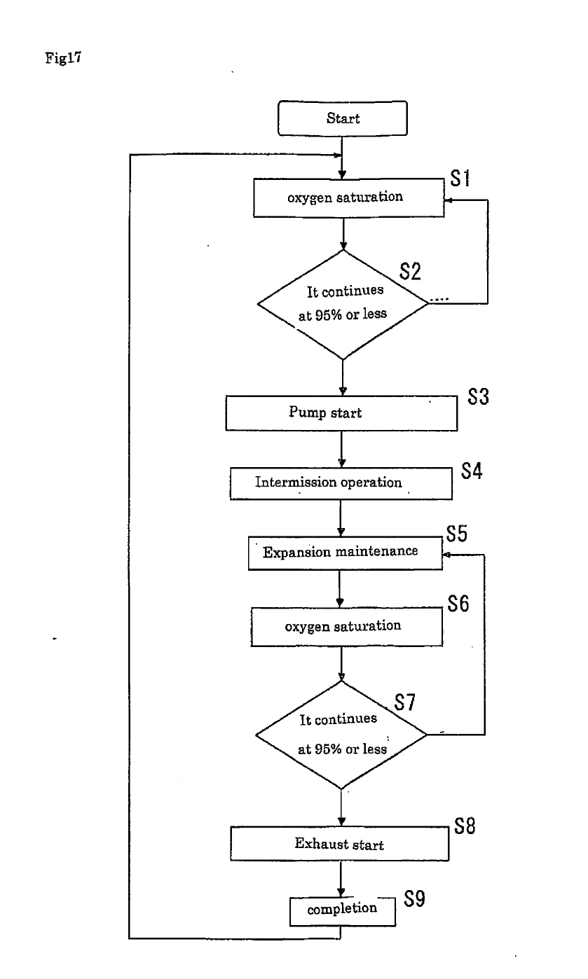

FIG. 16 shows the flow chart of the control procedure for controlling the oversupply of air.

In it, (a) expresses the flow of air supply (pressurization) and (b) expresses the flow of air exhaust (decompression).

In the inclination device for bedding, as the angle of gradient of the bed is formed, when a user separate from the inclination device for bedding, the control means which prevents supply of the air to air bags from being made more than its capacity is needed on the viewpoint of safety.

That is, in order to prevent the pressurization more than the capacity of air bags set up in flow sensors (ultrasonic sensor etc.), even if it is in the midst of pressurizing for a user separating from the bed etc., when pressure reaches a preset value, decompression operation is started automatically.

The flow of the pressurization is shown by FIG. 16 (a).

In the first, Air is supplied to air bags from the air pump (Step S1).

After expanding arbitrary air bags etc., operation of the air pump is changed to intermission operation, and the expansion is maintained (Step S2).

The Operation of the valve system changes into closed state, the air supplied to air bags etc. is maintained as it is there, and, therefore, the expansion of air bags etc. is held for a predetermined period.

Then, the ultrasonic sensor is supervised so that air bags may not be pressurized more than capacity (Step S3).

Then, the ultrasonic sensor is supervised so that air may not be supplied more than the capacity of air bags (Step S3).

When the amount of supply of air is higher than the capacity, the pressure sensor supervises the danger of a burst of air bags (Step S4).

When the abnormality, the amount of supply of air is higher than the capacity, does not arise, the surveillance of Step S3 is continued.

When the abnormality arises (Step S6), Error handling, for example air bags are decompressed and it returns to the initial state, is performed.

On the other hand, when the amount of supply of air is higher than the capacity in Step S3, the abnormalities after the completion of the pressurization are supervised (Step S5).

That is, the air leak and the rise of pressure are supervised by the flow sensor and the pressure sensor.

When the abnormalities arise, the error handling, for example air bags are decompressed and it is returned to an initial state, is performed (Step S6).

When the abnormalities do not arise, it progresses to Step S7.

As shown in FIG. 16 (b), it is decompressed with a pump and the like.

In the first, the decompression is started (Step S1).

The air pump starts, the valve is operated and the air is exhausted from air bags (Step S2).

The exhaust (decompression) is continued under the surveillance of a flow sensor until the inclination surface becomes flat (Step S3).

When it is judged that it became flat, the decompression is stopped and advances to Step S4.

### Eighth Embodiment

The control method of the present eighth embodiment is explained.

FIG. 17 shows the flow chart of the control procedure of the inclination device according to the present embodiment 8.

In the First, the oxygen saturation monitor, which is not illustrated, screens sleep apnea syndrome under sleep (Step S1).

In the present embodiment 8, PULSOXMe300 (TEIJIN PHARMA, LTD.) is adopted as the oxygen saturation monitor.

The information acquired by the screening is analyzed by software DS-Me as oxygen saturation in blood SpO2 for every interval of memorizing (Step S2).

When the deficiency of oxygen in blood is checked by this analysis, i.e., when a predetermined threshold of oxygen saturation (for example SpO2 is less than 95%, and it continued 3 seconds or more) is checked, the detection signal is inputted into the CPU and the CPU recognizes generating of sleep apnea syndrome. Air is supplied to air bags from the air supply pump through the air feed pipes by this, and the air bag expands.

After expanding arbitrary air bags, operation of the pump is changed to intermission operation, and the expansion of air bags is maintained (Step S4).

The closed state is formed by the operation of a valve system, the air supplied to air bags remains there as it is, and the expanding state is held for a predetermined period (Step S5).

The inclination surface is made to incline rightward by these.

In the present embodiment, when holding the expanding state, the detection work of the deficiency of oxygen by the oxygen saturation monitor is resumed (Step S6).

Based on the detection result, the CPU recognizes the existence of sleep apnea syndrome (Step S7).

When the oxygen saturation monitor does not detect sleep apnea syndrome and the CPU has recognized the stop of the sleep apnea syndrome, the air is exhausted through the exhaust valve in the valve system (Step S8), and the expansion can be canceled by this (Step S9).

Subsequently, it is returned to Step S1.

Next, the inclination surface can be made to incline leftward by the same method as the above.

### Ninth Embodiment

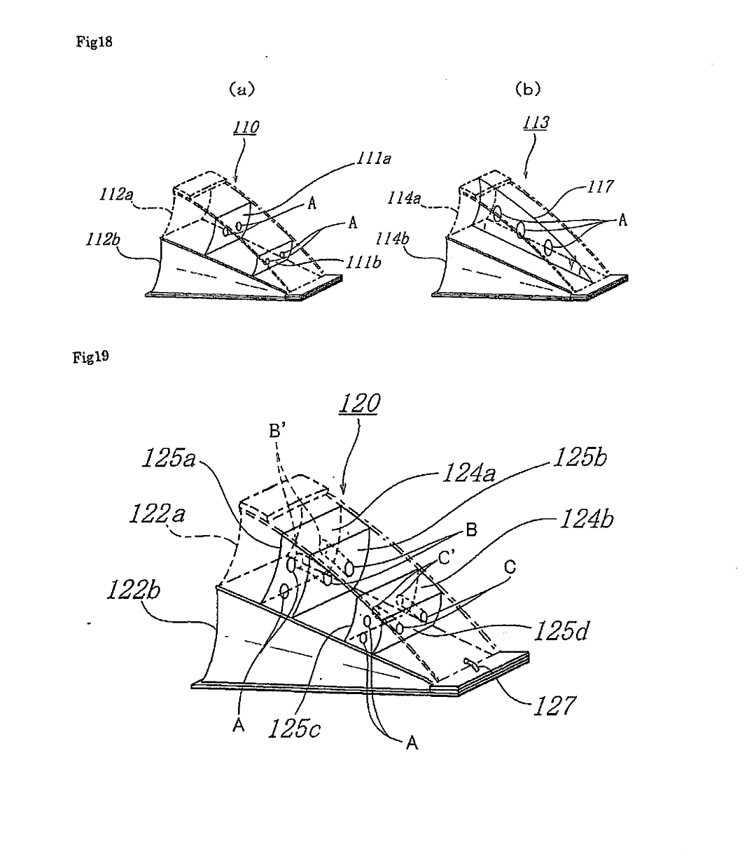

FIG. 18 shows a perspective diagram view of the air bag in the embodiment 9.

FIG. 18 (a) shows the perspective diagram of the air bags that have the partitions in it's inside.

In the inclination device of the present embodiment 9, air bag 112a is connected with air bag 112b.

If air bag 112a is made into an example, the partition 111a and 111b of the shape of a rectangle exist in the direction of the short hand in the inside of the air bag 112a.

“A” in FIG. 18 (a) shows the hole for air to be supplied to the entire inside of the air bag 112a.

When the air bag 112a expands by adopting such the structure, the surface of it does not become convex-like but the smoothness of the surface is maintained.

In FIG. 18 (a), although the two partitions exist in the inside of the air bag 112a, the only one partition may exist, and the three or more partitions may exist there.

FIG. 18 (b) shows the perspective diagram of the air bags that have the only one partition in it's inside.

In the inclination device of the present embodiment 9, air bag 114a is connected with air bag 114b.

If air bag 112a is made into an example, the partition 117 of the shape of a rectangle exist in the direction of the library temple in the inside of the air bag 114a.

“A” in FIG. 18 (b) shows the hole for air to be supplied to the entire inside of the air bag 114a.

When the air bag 114a expands by adopting such the structure, the surface of it does not become convex-like but the smoothness of the surface is maintained.

In FIG. 18 (b), although the only one partition exists in the inside of the air bag 114a, the two or more partitions may exist there.

### Tenth Embodiment

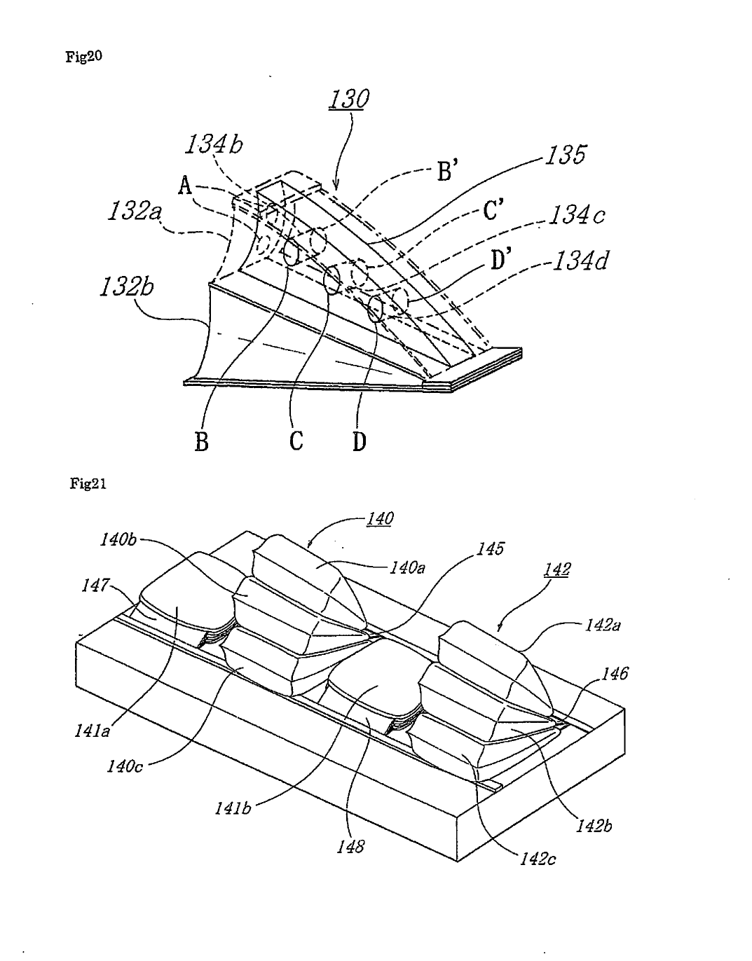

FIG. 19 shows a perspective diagram view of the air bags in the embodiment 10.

The air bag 120 in the present embodiment 10 has the structure that make two partitions 1 set.

Air bag 122a is connected with air bag 122b.

If air bag 122a is made into an example, the rectangular parallelepiped-like space 124a and 124b is formed in the inside of it.

The space 124a is formed with the partition 125a and 125b, and the space 124b is formed with the partition 125c and 125d as shown by FIG. 19.

“A” in FIG. 19 shows the hole for air exterior to air bag 122a, which is for its supply and exhaust.

If air is supplied to the air bag 122a through the air feed pipe 127, the air bag 122a will expand. Then, the hole A will functions in order to supply air.

On the other hand, when air is exhausted from the air bag 122a, the hole A functions in order to exhaust air.

The hole A may be formed in the partition of the side opposite to the partition with A shown in FIG. 19.

The adoption of such the structure will realize that the total amount of air required to expand the air bag 122a completely decreases through the feed pipe 127 and improvement in the speed of the inclination speed of the inclination surface.

When the air bag 114a expands, the existence of the partition 125a, 125b, 125c and 125d will realize that the surface of the air bag 122a does not become convex-like and that the smoothness of the surface is maintained.

“B” and “B′”, which are shown in FIG. 19, show the opening of the air passageway constructed in the inside of the space 124a. “C” and “C′”, which are shown in FIG. 19, also show the opening of the air passageway constructed in the inside of the space 124b.

These openings supply the air supplied through the air feed pipe 127 to the whole of the air bag except the space 124a and the space 124b.

In FIG. 19, although the rectangular parallelepiped-like space 124a and 124b is formed in the inside of the air bag 114a, the only one space may be formed in it, and the three or more spaces may be formed in it.

The number of the hole A and the number of the air passageway B, B′, C, and C′ can be changed.

### Eleventh Embodiment

FIG. 20 shows a perspective diagram view of the air bags in the embodiment 11.

The air bag 130 in the present embodiment 11 has the structure that make two partitions 1 set.

Air bag 132a is connected with air bag 132b.

If air bag 132a is made into an example, the rectangular parallelepiped-like space 135 is formed in the inside of it.

The space 135 is formed with the two partitions which are shown by FIG. 20.

“A” in FIG. 20 shows the hole for air exterior to air bag 132a, which is for its supply and exhaust.

If air is supplied to the air bag 132a through the air feed pipe, which is not shown by FIG. 20, the air bag 132a will expand. Then, the hole A will functions in order to supply exterior air.

On the other hand, when air is exhausted from the air bag 132a, the hole A functions in order to exhaust air.

The adoption of the space 135 will realize that the total amount of air required to expand the air bag 132a completely decreases through the feed pipe and improvement in the speed of the inclination speed of the inclination surface.

When the air bag 132a expands, the existence of the two partitions will realize that the surface of the air bag 132a does not become convex-like and that the smoothness of the surface is maintained.

“B”, “B′”, “C”, “C′”, “D” and “D′”, which are shown in FIG. 20, show the opening of the air passageway constructed in the inside of the space 135.

The air passageway 134b has “B” and “B′”, the air passageway 134c has “C” and “C′”, and the air passageway 134d has “D” and “D”

These openings supply the air supplied through the air feed pipe, which is not shown in FIG. 20, to the whole of the air bag 132a except the space 135.

In FIG. 20, although the rectangular parallelepiped-like space 135 only is formed in the inside of the air bag 132a, the two or more spaces may be formed in it.

The number and shape of the hole for air exterior to air bag can be changed and the number and shape of the air passageway can be changed also.

### Twelfth Embodiment

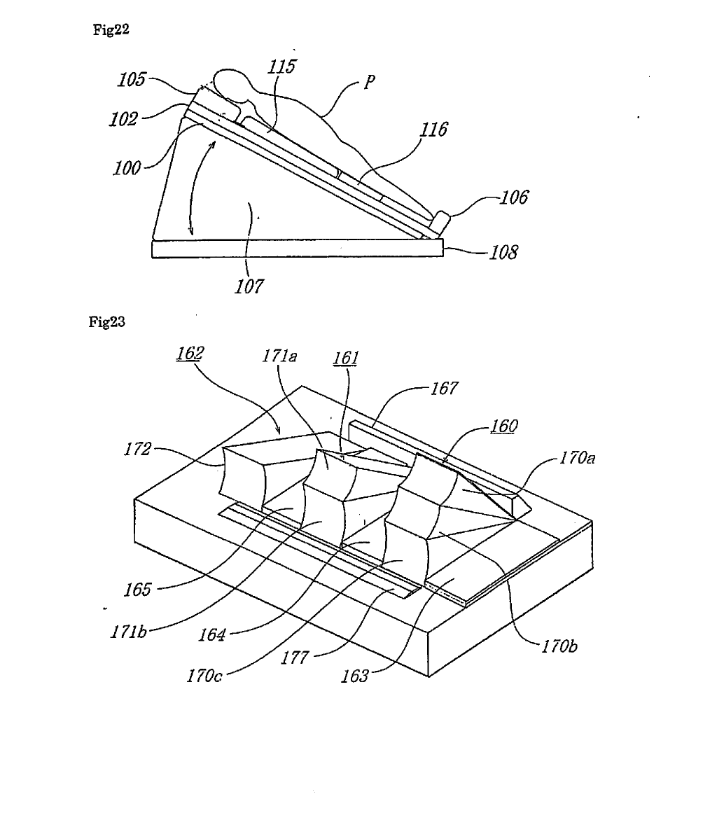

FIG. 21 shows a perspective diagram view of the air bags in the twelfth embodiment.

The inclination device for bedding in n the embodiment 12 has the air bags which make the right-and-left inclination of a laid user body carry out in the direction of a short hand.

FIG. 21 shows an example of the inclination device arranged under the inclination surface, which usually has a rectangular parallelepiped-like shape.

The air bag for making it incline toward the right, and the air bags 141a and 141b for a left inclination are arranged by turns in the direction of a library temple of bedding as shown by FIG. 21.

The two air bags 140 and 142 that make the inclination surface incline to the right and the two air bags 141a and 141b that make the inclination surface incline to the left are arranged by turns in the direction of a library temple of the inclination device for the bedding.

The air bag 140 has the three air bags 140a, 140b, and 140c which expand in the shape of an approximately triangular prism. The air bag 142 has the three air bags 142a, 142b, and 142c which expand in the shape of an approximately triangular prism.

In the inclination device for bedding of in the embodiment 12, the air bags 140a, 140b, and 140c are fixed setting the support part 145 as a central axis, and the air bags 142a, 142b, and 142c are fixed setting the support part 146 as a central axis.

When air is supplied to air bags, the air bags 140 and 142 can expand in the shape of the fan which has such the central axis, and make the inclination surface laid on the air bags incline toward the right.

On the other hand, when air is supplied to the air bags 141a and 141b, these bags expand in the shape of an approximately triangular prism, and make the inclination surface incline toward left-hand side.

The fixations are kept from jumping out with the pressure by the weight of a human body. The support part of the air bag, for example “146”, is desirable to be composed using such as buttons or fasteners for every air bags.

Such the attachment-and-detachment possibility for every air bag makes it possible to exchange only the damaged air bag for a new air bag.

In addition, each air bag 140, 141a, 141b, and 142 can be covered with cloth or the like.

By covering with the cloth suitable for the size at the time of expansion of air bags, surplus supply of air and the swelling in the central portion of air bags can be prevented.

The embodiment 13

FIG. 22 shows a perspective diagram view of the inclination device for bedding in the embodiment 13.

The pillow 105, the bed 115 for chests, and the bed 116 for legs are arranged on the inclination surface 102 as shown by FIG. 22.

The pillow 105 holds the head of user body P which is lying down.

The pillow 105 is desirable to be penetrated in the parts which come in contact with eyes, a nose, and a mouth of a user body.

The adoption of such the structure can prevents pressure of eyes, a nose, and a mouth of a user in a proneness state, makes breathing under sleep easy, and offers comfortable sleep. The bed 115 for chests is arranged in order to hold the upper half of the body of a user body P.

The bed 115 is desirable to be penetrated in the portion equivalent to a lung. The bed 115 is penetrated in the portion equivalent to a stomach.

The adoption of such the structure can prevents pressure of lungs and a stomach of a user in a proneness state, makes breathing under sleep easy, and offers comfortable sleep.

The bed 116 for legs is arranged on the inclination surface in order to hold a part of legs of a user body P.

The safety stopper 106 which has low rebounding urethane mats is arranged on the inclination surface near the soles of a user under sleep.

The inclination device for bedding of the present embodiment 13 has the air bag 107 under the inclination surface 102. The air bag 107 makes the inclination surface incline in the direction of a library temple.

The inclination device for bedding of the present embodiment 13 has features of the rise on the head side and the inclination to the direction of a library temple as shown in FIG. 22. The inclination device 107 makes a inclination surface incline in the direction of a library temple. This is arranged on the base sheets 108 such as a bed or a floor.

This inclines gradually so that the parietal region of a user who is sleeping in a prone position. The inclination stops in the set-up position.

It is appropriate to make the set-up position into a maximum of about 45 degrees.

This inclines gradually so that the parietal region of a user who is sleeping in a prone position.

After the preset stop time passes, the inclination can be canceled.

The adoption of such a structure makes it expect to urge more smooth urination and defecation. Moreover, the adoption makes it expect to stop going down the wrong pipe and assist suitable digestion.

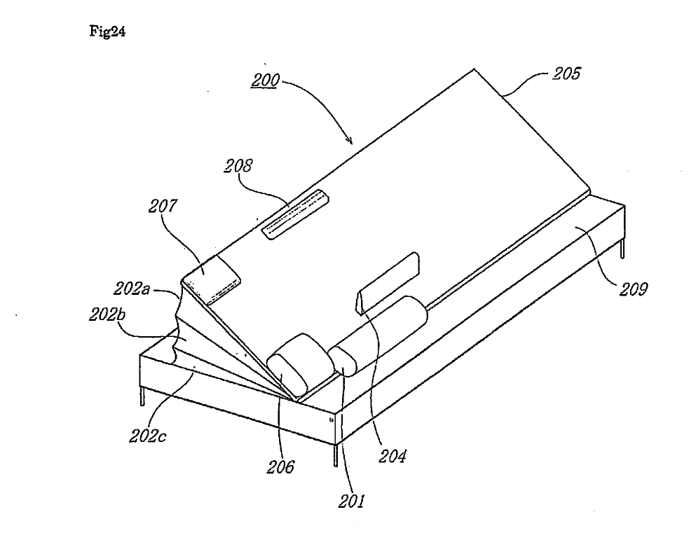

FIG. 23 shows a perspective diagram view of an example of the inclination device for bedding of the present embodiment 13.

As shown by FIG. 23, the air bag (for example “160”, “161” and “162”) that makes the inclination surface incline to the right and the two air bag (for example “163”, “164” and “165”) that makes the inclination surface incline to the left are arranged by turns in the direction of a library temple of the inclination device for the bedding.

Sequentially from the head side of a user body laid on the bedding, “163”, “160”, “164”, “161”, “165”, and “162” are arranged.

The air bags 160, 161, and 162 have the one or two or more air bags which expand in the shape of an approximately triangular prism.

The air bag 160 made to incline toward the right has the three-step pile of 170a, 170b, and 170c.

The air bags 170a, 170b, and 170c are fixed setting the support part as a central axis.

When air is supplied to the air bags, the air bag 160 can expand in the shape of the fan which has such the central axis, and makes the inclination surface laid on the air bags incline toward the right.

The air bag 161 made to incline toward the right has the two-step pile of 171a, and 171b. The air bags 171a and 171b are fixed setting the support part as a central axis.

When air is supplied to the air bags, the air bag 161 can expand in the shape of the fan which has such the central axis, and makes the inclination surface laid on the air bags incline toward the right.

The air bag 162 made to incline toward the right only has the air bag 172.

When air is supplied to the air bags, the air bag 162 can expand in the shape of the fan which has such the central axis, and makes the inclination surface laid on the air bags incline toward the right.

In the inclination device of the present embodiment 13, the angle of gradient of the air bag becomes low gradually from the head of the human body laid on bedding toward a step.

Thus, if air is supplied to a air bag, the head side of a user body laid on bedding will go up more highly than the step of him.

The air bag 163 made to incline toward the left has the three-step pile of the air bags.

The air bag 164 made to incline toward the left has the two-step pile of the air bags.

The air bag 165 made to incline toward the left has the only one air bag.

The arbitrary adjusting the width of each air bags and the pile of each air bags can make possible the angle of gradient suitable for each part of the human body laid in a bed.

“167” and “177” in FIG. 23 show the safety stopper for the prevention from user body fall. In FIG. 23, because the inclination surface inclines toward the right, only the right-hand side safety stopper 167 expands.

The embodiment 14

FIG. 24 shows a perspective diagram view of the inclination device for bedding in the embodiment 14.

The inclination device 200 of the present embodiment 14 is suitable when a user mainly sleep on his back.

FIG. 24 shows the scene where the inclination surface of the inclination device 200 inclines toward the right.

Although not shown by FIG. 24, the inclination surface of the inclination device 200 can incline also toward the left.

In the inclination device for beddings of the present embodiment 14, the air bags which make the inclination surface incline toward the right has the three-step pile of the air bag, which are 202a, 202b, and 202c in FIG. 24.

The air bags 202a, 202b, and 202c are fixed setting the ridge close to the smallest angle of the triangle of a triangular prism as a central axis.

When air is supplied to the air bags through the air feed pipe which is not shown in FIG. 24, the air bag which has the air bags 202a, 202b, and 202c can expand in the shape of the fan which has such the central axis. Then, the inclination surface 205 on a air bag inclines toward the right.

Simultaneously with the inclination, air is supplied to the head support pillow 206 to support the temporal region of head of a user who sleeps on his back, and air is supplied also to the first safety stopper 204 and the second safety stopper 201.

The first stopper 204 mainly supports a user's flank and prevents a user body from sliding down from the inclination surface.

The second safety stopper 201 mainly supports the right shoulder of a user body and prevents a user body from sliding down from the inclination surface.

When the inclination surface inclines and a user body becomes sideways, the user unconsciously spreads his left arm over the second safety stopper 201. Thus, the second safety stopper 201 can prevent a user's fatigue, and can give a user comfortable sleep.

In FIG. 24, the head support pillow 207 and the first safety stopper 208 are in the state where it faded. However, when the inclination surface inclines toward the left, the head support pillow 207 and the first safety stopper 208 expand.

The second safety stopper which expands when the inclination surface inclines toward the left is not shown by FIG. 24, because the second safety stopper is hidden by the inclination surface 205.

However, the second safety stopper is arranged on the bed 209.

### EXPLANATION OF SYMBOLS

1,5,39,75,105: pillow
2,6: the concave portion
3,7,15,32,42,52,53,82,107: air
4,14: the component which adjusts height
9: the component which adjusts length
11,71,115: the bed for breasts
12,72: the portion equivalent to a lung
13,73: the portion equivalent to a stomach
19: inside air bag
30,31,32a,32b,34a,34b,40,41,140,142,141a,141b: air bag
33,34,145,146: support part
35,55,85,102: slope
36,56: bed
37,47,58,84,106: Safety stopper
50: the inclination device for bedding
56: bed
74,116: bed for leg
76,77: support part
100: the inclination device for bedding
P: human body

1. The inclination device for bedding is provided with a rectangular inclination surface on which the human body rests, and a air bag that is disposed below the inclination surface and expands into a triangular column shape, rectangular shape, globular shape, sector shape or cylinder shape by providing a air, and a support part which is a long part at both ends of the inclination surface is disposed at a location where the support part is in contact with the bedding, and the inclination surface can be inclined left and right by providing air to the air bag, with the support part of the inclination surface serving as the fulcrum,

2. The inclination device for bedding according to claim 1, wherein said air bag which air bag for a left inclination which expands so that air bag nay make a slope incline on the left and air bag for a left inclination which expands so that air bag nay make a slope incline on the left are arranged by turns in the direction of a library temple of bedding.

3. The inclination device for bedding according to claim 1, wherein tow or more air bags is arrange in pile that is disposed below said inclination surface, and air bag expands in the shape of a fan by using as a fulcrum the portion to which air bags was fixed to in the support part, and air bag was fixed by supplying air to the said air bags.

4. The inclination device for bedding according to claim 1, wherein a cold air current or a stream of warm air is supplied to a slope by air bag being dual structure, forming the exhaust nozzle of air in the undersurface of inside air bag, forming the exhaust nozzle of air in the upper surface of outside air bag, and supplying cold or warmth to inside air bag.

5. The inclination device for bedding according to claim 1, wherein the air bag expands in a form which raises the parietal region side of a human body.

6. The inclination device for bedding according to claim 1, that is disposed the auxiliary implement for bedding is arranged under the human body lain prone.

7. The inclination device for bedding according to claim 6, wherein said auxiliary implement has a pillow holding the head in a human body, and the concave portion is formed in the part which is equivalent to the eye, a nose and a mouth in human body at the said pillow.

8. The inclination device for bedding according to claim 7, wherein said auxiliary implement for bedding has an auxiliary implement for legs, and guide component which supports a leg is formed in the part where said auxiliary implement for legs is equivalent to the root of the leg in a human body.

9. The inclination device for bedding according to claim 7, wherein said auxiliary implement for bedding which prevents fall of a human body is formed in said auxiliary implement for bedding.

10. The inclination device for bedding according to claim 7, wherein an air bag is disposed below auxiliary implement.

11. The inclination device for bedding according to claim 10, wherein a cold air current or a stream of warm air is supplied to a slope by air bag being dual structure, forming the exhaust nozzle of air in the undersurface of inside air bag, forming the exhaust nozzle of air in the upper surface of outside air bag, and supplying cold or warmth to inside air bag.

12. The inclination device for bedding according to claim 1, wherein the partition of a rectangular shape, square shape or triangle was formed in said air bag.

13. The inclination device for bedding according to claim 1, when the oxygen concentration of saturated solution in blood is measured, and said oxygen concentration of saturated solution exceeds a predetermined threshold value from the laid human body, a driving signal is transmitted and a slope is made to incline right and left.

14. The inclination device for bedding according to claim 1 when the air pressure in air bag is measured with a pressure sensor and said pressure exceeds a predetermined threshold value, air is discharged from air bag.
